(19) United States
(12) Patent Application Publication
(10) Pub. No.: US 2016/0032034 A1
(43) Pub. Date: Feb. 4, 2016

(54) HAFNOCENE CATALYZED POLYETHYLENE FILMS HAVING RAPID CLING DEVELOPMENT

(71) Applicant: UNIVATION TECHNOLOGIES, LLC, Houston, TX (US)

(72) Inventors: James M. Farley, Houston, TX (US); Phillip A. Adetunji, Victoria (AU); Stephen J. Mirams, Victoria (AU); Gerald L. Beckton, Victoria (AU)

(73) Assignee: Univation Technologies, LLC, Houston, TX (US)

(21) Appl. No.: 14/775,968

(22) PCT Filed: Mar. 14, 2014
(86) PCT No.: PCT/US14/28790

§ 371 Date: Sep. 14, 2015

Related U.S. Application Data
(60) Provisional application No. 61/790,807, filed on Mar. 15, 2013.

(51) Int. Cl. C08F 210/16; B29C 47/00; C08J 5/18; B29C 47/06

(52) U.S. Cl. CPC C08F 210/16; B29C 47/06; B29C 47/0054; B29C 47/0021; C08J 5/18; B29K 2023/06; B29K 2023/0625

(57) ABSTRACT

Polyethylene films may include a polyethylene copolymer polymerized in the presence of a hafnium-based metallocene catalyst, wherein the polyethylene comprises a solubility distribution breadth index (SDBI) less than or equal to 23° C.; a melt index (12) less than 1.5; a flow index (121) of from about 16 to about 28; and a melt flow ratio (121/12) of from about 18 to about 23. The film has a cling value that is at least 60% of a cling value the film has at 48 hours after time zero, and wherein time zero is equal to less than 24 hours.

### FIELD

Embodiments described herein generally relate to films made from hafnocene catalyzed polyethylenes. More particularly, such embodiments relate to stretch films having an improved rate of cling development.

### BACKGROUND

Stretch films are widely used in a variety of bundling and packaging applications. One particular application, for example, is for bundling goods for shipping and storage. Stretch films or stretch cling films having high cling properties are particularly useful because the high cling helps prevent unraveling of the film from the bundled goods. To improve the cling properties of a stretch film a number of techniques have been used including the addition of one or more tackifying additives or “tackifiers” to the polymer prior to formation of the film via an extrusion, cast, or blown film process, for example. Such tackifiers include polybutenes, low molecular weight polyisobutylenes (PIB), polyterpenes, amorphous polypropylene, ethylene vinyl acetate copolymers, microcrystalline wax, alkali metal sulfosuccinates, and mono- and di-glycerides of fatty acids.

Even with the use of such tackifying additives, however, the development of a film's cling can range widely from a few hours to a few days, a week, or even more to fully develop. As the delay in cling development increases, the ability to use the polymer for stretch film applications decreases. Additionally, more space is required for storing the film during the development of the film's cling as the delay in that development increases.

There is a need, therefore, for stretch cling films having an improved rate of cling development.

### SUMMARY OF THE INVENTION

Polyethylene films and methods for making and using same are provided. The method for making the polyethylene can include contacting ethylene and one or more comonomers with a hafnium-based metallocene catalyst within a gas phase polymerization reactor at a temperature of from 80° C. to 88° C. The ethylene partial pressure in the reactor may range from about 825 kPa to about 1,800 kPa. The polyethylene produced may have a solubility distribution breadth index (SDBI) less than or equal to 23° C.; and a melt flow ratio (I21/I2) of from about 18 to about 23. The polyethylene may then be combined with at least one tackifier to produce a blended mixture. The blended mixture may then be formed into a film, wherein at a time zero after forming the film, the film has a cling value that is at least 60% of a cling value the film has at 48 hours after time zero, and wherein time zero is equal to less than 24 hours.

Exemplary, non-limiting polyethylene films may include blown films. The blown film may include a polyethylene copolymer polymerized in the presence of a hafnium-based metallocene catalyst, wherein the polyethylene comprises a solubility distribution breadth index (SDBI) less than or equal to 23° C.; a melt index (I2) less than 1.5; a flow index (I21) of from about 16 to about 28; and a melt flow ratio (I21/I2) of from about 18 to about 23. The blown film has a cling value that is at least 60% of a cling value the film has at 48 hours after time zero, and wherein time zero is equal to less than 24 hours.

### BRIEF DESCRIPTION OF THE DRAWINGS

FIG. 1 depicts a graphical representation of the solubility distribution breadth index (SDBI) for polyethylene polymers (Ex. 1-7) versus polymerization temperature.

FIG. 2 depicts a graphical representation of the melt index ratio (MIR) versus polymerization temperature for the polyethylene polymers (Ex. 1-7).

FIG. 3 depicts a graphical representation of the rate of cling development versus time for polyethylene films (Ex. 8 and comparative examples C1-C3).

### DETAILED DESCRIPTION

It has been surprisingly found that contacting ethylene and one or more comonomers with a hafnium-based metallocene catalyst within a gas phase polymerization reactor under appropriate conditions, e.g., reactor temperature and/or ethylene partial pressure, can produce a polyethylene for making films that have an accelerated rate of cling development. For example, at time zero after forming the polyethylene film, the polyethylene film can have a cling value that is at least 60%, at least 63%, at least 65%, at least 67%, at least 70%, at least 73%, at least 75%, at least 77%, at least 80%, at least 83%, at least 85%, at least 87%, or at least 90% of the cling value the film has at 48 hours after forming the polyethylene film. As used herein, the term “time zero” is the time after forming the polyethylene film that the cling value of the polyethylene film is measured and is less than 24 hours. In another example, at time zero the polyethylene film can have a cling value that is equal to a low of about 62%, about 66%, about 72%, about 74%, or about 76% to a high of about 82%, about 84%, about 86%, about 88%, or about 92% of the cling value of the polyethylene film at 48 hours after forming the polyethylene film.

The term “polyethylene” refers to a polymer having at least 50 wt % ethylene-derived units, preferably at least 70 wt % ethylene-derived units, more preferably at least 80 wt % ethylene-derived units, or 90 wt % ethylene-derived units, or 95 wt % ethylene-derived units, or 100 wt % ethylene-derived units. The polyethylene can thus be a homopolymer or a copolymer, including a terpolymer, having one or more other monomeric units. As such, the polyethylene can include, for example, one or more other olefin(s) and/or α-olefin comonomer(s). Suitable α-olefin comonomers can be linear or branched or can include two unsaturated carbon-carbon bonds (dienes). Illustrative α-olefin comonomers can include, but are not limited to, those having from 3 to about 20 carbon atoms, such as C₃-C₂₀ α-olefins, C₃-C₁₂ α-olefins, or C₃-C₈ α-olefins. One, two, or more comonomers can be used. Examples of additional suitable comonomers can include, but are not limited to, linear C₃-C₁₂ α-olefins and α-olefins having one or more C₁-C₃ alkyl branches or an aryl group. Specific examples of such comonomers include propylene; 1-butene; 3-methyl-1-butene; 3,3-dimethyl-1-butene; 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene; and combinations thereof. Particularly preferred comonomers include 1-butene, 1-hexene, and 1-octene.

As noted above, the rate of cling development can be influenced, adjusted, tailored, modified, altered, or otherwise controlled by controlling the polymerization temperature or by controlling the ethylene partial pressure or both during polymerization. For purposes of this disclosure the phrases “polymerization temperature” and “reactor temperature” are used interchangeably and refer to the temperature of the reaction mixture, i.e., the catalyst, ethylene, one or more comonomers, and other components, within the polymerization reactor. The ethylene and the comonomer can be polymerized within the gas phase reactor at a reactor temperature or polymerization temperature from a low of about 70° C., about 74° C., about 78° C., or about 80° C. to a high of about 88° C., about 92° C., about 96°, or about 98° C. For example, the polymerization temperature can be from about 80° C. to about 88° C., about 81° C. to about 87° C., about 82° C. to about 86° C., about 83° C. to about 85° C., about 82° C. to about 85° C., or about 83° C. to about 86° C. In another example, polymerization temperature can be at least 80° C., at least 80.5° C., at least 81° C., at least 81.5° C., at least 82° C., at least 82.5° C., at least 83° C., or at least 83.5° C. to about 85° C., about 86° C., about 87° C., or about 88° C. In another example, the polymerization temperature can be less than 88° C., less that 87.5° C., less than 87° C., less than 86.5° C., less than 86° C., less than 85.5° C., or less than 85° C. and at least 80° C., at least 80.5° C., at least 81° C., at least 81.5° C., at least 82° C., at least 82.5° C., about 83° C., at least 83.5° C., or at least 84° C.

The ethylene partial pressure within the reactor can be from a low of about 800 kPa, about 825 kPa, about 850 kPa, about 875 kPa, or about 900 kPa to a high of about 1,500 kPa, about 1,700 kPa, about 1,900 kPa, or about 2,100 kPa, during polymerization of the ethylene and the comonomer. For example, the ethylene partial pressure can be from about 825 kPa to about 1,800 kPa, about 750 kPa to about 1,500 kPa, about 1,000 kPa to about 2,200 kPa, about 800 kPa to about 1,400 kPa, or about 1,200 kPa to about 1,750 kPa. In another example, the ethylene partial pressure can be from about 1,400 kPa to about 1,600 kPa, about 1,450 kPa to about 1,550 kPa, about 1,300 kPa to about 1,450 kPa, about 1,450 kPa to about 1,525 kPa, or about 1,500 kPa to about 1,575 kPa.

The total pressure within the reactor can be from a low of about 900 kPa, or about 1,000 kPa to a high of about 2,500 kPa, about 3,000 kPa, or about 3,500 kPa. For example, the reactor pressure can be from about 1,375 kPa to about 3,450 kPa, about 1,700 kPa to about 3,000 kPa, about 2,000 kPa to about 2,600 kPa, or about 2,100 kPa to about 2,300 kPa. In another example, the total reactor pressure can be from about 2,100 kPa to about 2,250 kPa, about 1,900 kPa to about 2,250 kPa, about 1,750 kPa to about 2,450 kPa, or about 2,050 kPa to about 2,350 kPa.

The molar ratio of the one or more comonomers to ethylene can be from a low of about 0.01, about 0.0125, or about 0.015 to a high of about 0.017, about 0.0185, or about 0.02. For example, the molar ratio of the one or more comonomers to ethylene can be from about 0.01 to about 0.02, about 0.012 to about 0.019, about 0.013 to about 0.018, about 0.014 to about 0.0175, or about 0.014 to about 0.18. In another example, the molar ratio of the one or more comonomers to ethylene can be at least 0.012, at least 0.013, at least 0.014, at least 0.015, or at least 0.016 and less than 0.02, less than 0.018, less than 0.017, or less than 0.0165.

The polyethylene can have a composition distribution as measured by solubility distribution breadth index (SDBI) from a low of about 18° C., about 19° C., or about 20° C. to a high of about 21° C., about 22° C., or about 23° C. For example, the polyethylene can have a SDBI of between about 18° C. and less than 23° C., less than 22.7° C., less than 22.5° C., less than 22.3° C., less than 22° C., less than 21.7° C., or less than 21.5° C. In another example, the polyethylene can have a SDBI of about 18° C. up to 24° C., about 18.5° C. up to 23° C., about 19° C. up to 22.8° C., about 20° C. up to 22.6° C., about 20.5° C. up to 22.4° C., about 19.5° C. up to 22.2° C., or about 20° C. up to 22° C.

The TREF (Temperature Rising Elution Fractionation) data reported herein, i.e., the SDBI values, can be measured with an analytical size TREF instrument (Polymerchar, Spain), with a column having the following dimensions: inner diameter (ID) 7.8 mm and outer diameter (OD) 9.53 mm and a column length of 150 mm. The column can be filled with steel beads. About 0.5 mL of a 6.4% (w/v) polymer solution in orthodichlorobenzene (ODCB) containing 6 g BHT/4 L can be introduced into the column and cooled from 140° C. to 0° C. at a constant cooling rate of about 1.0° C./min. After cooling the polymer solution to 0° C., ODCB can be pumped through the column at a flow rate of about 1.0 ml/min, and the column temperature can be increased at a constant heating rate of 2° C./min to elute the polymer. The polymer concentration in the eluted liquid can be detected by means of measuring the absorption at a wave number of 2857 cm¹′ using an infrared detector. The concentration of the ethylene-α-olefin copolymer in the eluted liquid can be calculated from the absorption and plotted as a function of temperature. SDBI values can be calculated using commercially available software such as the software available from Polymer Char, Valencia, Spain.

The polyethylene can have a density from a low of about 0.86 g/cm³, about 0.88 g/cm³, about 0.90 g/cm³, or about 0.905 g/cm³, to a high of about 0.92 g/cm³, about 0.94 g/cm³, about 0.96 g/cm³, or about 0.97 g/cm³. For example, the polyethylene can have a density from about 0.90 g/cm³ to about 0.93 g/cm³, about 0.905 g/cm³ to about 0.925 g/cm³, about 0.91 g/cm³ to about 0.94 g/cm³, or about 0.913 g/cm³ to about 0.919 g/cm³. The density of the polyethylene can be measured in accordance with ASTM-D-792.

The polyethylene can have a melt index (I₂) of from a low of about 0.1 g/10 min, about 0.2 g/10 min, about 0.5 g/10 min, or about 0.7 g/10 min to a high of about 1.2 g/10 min, about 1.4 g/10 min, about 1.6 g/10 min, about 1.8 g/10 min, about 2 g/10 min, about 2.5 g/10 min, about 3 g/10 min, or about 4 g/10 min. For example, the polyethylene can have a melt index from about 0.3 g/10 min to about 3 g/10 min, about 0.7 g/10 min to about 1.5 g/10 min, or about 0.8 g/10 min to about 1.2 g/10 min. In at least one specific embodiment, the polyethylene can have a melt index (I₂) less than 3, less than 2.5, less than 2, less than 1.7, less than 1.5, less than 1.4, less than 1.3, less than 1.2, or less than 1.1 and greater than 0.5 g/10 min, greater than 0.7 g/10 min, greater than 0.8 g/10 min or greater than 0.9 g/10 min. The melt index (I₂) can be measured in accordance with ASTM D-1238 (at 190° C., 2.16 kg weight).

The polyethylene can have a flow index (I₂₁) of from a low of about 15 g/10 min, about 16 g/10 min, about 17 g/10 min, or about 18 g/10 min to a high of about 24 g/10 min, about 25 g/10 min, about 26 g/10 min, about 27 g/10 min, about 28 g/10 min, about 29 g/10 min, about 30 g/10 min, or about 31 g/10 min. For example, the polyethylene can have a flow index (I₂₁) from about 16 g/10 min to about 28 g/10 min, about 17 g/10 min to about 23 g/10 min, or about 18 g/10 min to about 22 g/10 min. In at least one specific embodiment, the polyethylene can have a melt index (I₂) less than 28, less than 27, less than 26, less than 25, less than 24, or less than 23 and greater than 16 g/10 min, 18 g/10 min, greater than 19 g/10 min, greater than 19.5 g/10 min, or greater than 20 g/10 min. The flow index (I₂₁) can be measured in accordance with ASTM D-1238 (at 190° C., 21.6 kg weight).

The terms “Melt Index Ratio,” “MIR,” and “I₂₁/I₂” are used interchangeably and refer to the ratio of I21 to I2. The polyethylene can have a MIR from a low of about 18, about 19, or about 20 to a high of about 22, about 23, about 24, about 25, or about 26. For example, the polyethylene can have a MIR of from about 18 to about 23.5, about 18 to about 23, about 18.5 to about 22.5, about 19 to about 22.3, about 20 to about 22, about 20.5 to about 22, about 21 to about 22, or about 18.5 to about 22.7. In another example, the polyethylene can have a MIR of less than 24 to about 18, less than 23.5 to about 18.5, less than 23 to about 19, less than 22 to about 20, or less than 22.5 to about 20.5.

The terms “molecular weight distribution” and “MWD” means the same thing as the term “polydispersity index” or “PDI.” The molecular weight distribution (MWD) is the ratio of weight-average molecular weight (Mw) to number-average molecular weight (Mn), i.e. Mw/Mn. The weight average (Mw), number average (Mn), and z-average (Mz) molecular weights can be measured using gel permeation chromatography (GPC), also known as size exclusion chromatography (SEC). This technique utilizes an instrument containing columns packed with porous beads, an elution solvent, and detector in order to separate polymer molecules of different sizes. Measurement of molecular weight by SEC is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; and Verstrate et al., Macromolecules, vol. 21, (1988) 3360; T. Sun et al., Macromolecules, Vol. 34, (2001) 6812-6820.

The polyethylene can have a weight average molecular weight (Mw) from a low of about 70,000, about 80,000, about 90,000, or about 100,000 to a high of about 110,000, about 130,000, or about 150,000. For example, the Mw of the polyethylene can be from about 75,000 to about 140,000, about 85,000 to about 115,000, about 95,000 to about 115,000, about 95,000 to about 105,000, about 105,000 to about 115,000, or about 90,000 to about 120,000.

The polyethylene can have a number average molecular weight (Mn) of from a low of about 20,000, about 25,000, or about 30,000 to a high of about 40,000, about 45,000, or about 50,000. For example, the Mn of the polyethylene can be from about 22,000 to about 42,000, about 28,000 to about 42,000, about 36,000 to about 46,000, about 29,000 to about 41,000, or about 25,000 to about 35,000.

The polyethylene can have a MWD or Mw/Mn of greater than 2.0 to about 5, greater than 2.2 to about 4.5, greater than about 2.4 to less than about 3.0, or from about 2.5 to about 2.8. The polyethylene have a ratio of z-average molecular weight to weight average molecular weight (Mz/Mw) of from a low of about 2.1, about 2.2, or about 2.3 to a high of about 2.4, about 2.5, about 2.6, or about 2.7. For example, the polyethylene can have a Mz/Mw of about 2.1 to about 2.7, about 2.1 to about 2.6, about 2.2 to about 2.5, about 2.3 to about 2.6, about 2.6 to about 2.9, or about 2.4 to about 2.8.

A 25 μm film made from the polyethylene by a blown film process can have a 1% secant flexural modulus in the machine direction (MD) of greater than 20,000 psi, greater than 21,000 psi, greater than 22,000 psi, greater than 23,000 psi, greater than 24,000 psi, greater than 25,000 psi, greater than 26,000 psi, greater than 27,000 psi, greater than 28,000 psi, or greater than 29,000 psi. For example, the polyethylene film can have a 1% secant modulus in the machine direction from greater than 25,000 psi to about 33,000 psi, about 25,300 psi to about 32,000 psi, or about 25,700 psi to about 31,000 psi. The polyethylene film can have a 1% secant modulus in the transverse direction (TD) of greater than 20,000 psi, greater than 21,000 psi, greater than 22,000 psi, greater than 23,000 psi, greater than 24,000 psi, greater than 25,000 psi, greater than 26,000 psi, greater than 27,000 psi, greater than 28,000 psi, or greater than 29,000 psi. For example, the polyethylene film can have a 1% secant modulus in the transverse direction from greater than 25,000 psi to about 40,000 psi, about 25,300 psi to about 38,000 psi, or about 25,700 psi to about 37,500 psi. The 1% secant flexural modulus (machine direction and transverse direction) can be measured according to ASTM D790-10 (Procedure A, 1.3 mm/min).

A 25 μm film made from the polyethylene by a blown film process can have a dart impact resistance of greater than 300 g/mil, greater than 400 g/mil, greater than 450 g/mil, greater than 500 g/mil, greater than 550 g/mil, or greater than 600 g/mil. For example, the polyethylene film can have a dart impact resistance of at least 500 g/mil to about 1,000 g/mil, about 515 g/mil to about 975 g/mil, about 525 g/mil to about 950 g/mil, about 575 g/mil to about 975 g/mil, or about 625 g/mil to about 1,000 g/mil. The dart impact resistance of the polyethylene film can be measured according to ASTM D-1709-09 (Method A).

A 25 μm film made from the polyethylene by a blown film process can have a machine direction (MD) tear strength (Elmendorf tear) less than 500 g/mil, less than 475 g/mil, less than 450 g/mil, less than 425 g/mil, less than 400 g/mil, less than 350 g/mil, less than 300 g/mil, less than 275 g/mil, or less than 250 g/mil. For example, the polyethylene film can have a machine direction (MD) tear strength from about 230 g/mil up to about 490 g/mil, about 260 g/mil to about 480 g/mil, about 235 g/mil to about 420 g/mil, about 220 g/mil to about 360 g/mil, about 230 g/mil to about 320 g/mil, or about 240 g/mil to about 325 g/mil. The machine direction (MD) tear strength (Elmendorf tear) can be measured according to ASTM D-1922.

A 25 μm film made from the polyethylene by a blown film process can have a transverse direction (TD) tear strength (Elmendorf tear) from a low of about 400 g/mil, about 425 g/mil, or about 450 g/mil to a high of about 465 g/mil, about 480 g/mil, or about 495 g/mil. For example, the polyethylene film can have a transverse direction (TD) tear strength from about 410 g/mil to about 460 g/mil, about 420 g/mil to about 455 g/mil, about 430 g/mil to about 470 g/mil, about 440 g/mil to about 470 g/mil, about 440 g/mil to about 455 g/mil, or about 435 g/mil to about 460 g/mil. The machine direction (MD) tear strength (Elmendorf tear) can be measured according to ASTM D-1922. A ratio of the MD tear strength to the TD tear strength (MD tear/TD tear) can be less than or equal to 0.8, less than or equal to 0.7, or less than or equal to 0.6, or less than or equal to 0.5. For example, the ratio of the MD tear strength to the TD tear strength can be from about 0.4 to about 0.9.

A 25 μm film made from the polyethylene by a blown film process can have a puncture strength resistance or puncture force (pounds per mil or lb/mil) of from a low of about 8.2, about 8.5 lb/mil, about 8.8 lb/mil, about 9 lb/mil, or about 9.2 lb/mil, to a high of about 9.6 lb/mil, about 10 lb/mil, about 10.5 lb/mil, or about 11 lb/mil. In one or more embodiments, the polyethylene film can have a puncture force of at least 8.6 lb/mil, at least 8.9 lb/mil, at least 9.2 lb/mil, or at least 9.4 lb/mil to about 9.8 lb/mil, about 10.2 lb/mil, about 10.6 lb/mil, or about 11 lb/mil. For example, the polyethylene film can have a puncture strength resistance of from about 9.4 lb/mil to about 10.8 lb/mil, about 8.5 lb/mil to about 11 lb/mil, or about 9.3 lb/mil to about 11 lb/mil.

A 25 μm film made from the polyethylene by a blown film process can have a gloss in the machine direction of about 25 or more, about 26 or more, about 27 or more, about 28 or more, about 29 or more about 30 or more, about 31 or more, about 32 or more, or about 33 or more. For example, the 25 μm film can have a gloss in the machine direction of from about 26 to about 33, about 27 to about 32, about 26 to about 31, about 28 to about 32, or about 29 to about 33. A 25 μm film made from the polyethylene by a blown film process can have a gloss in the transverse direction of about 25 or more, about 26 or more, about 27 or more, about 28 or more, about 29 or more about 30 or more, about 31 or more, about 32 or more, about 33 or more, about 34 or more, or about 35 or more. For example, the 25 μm film can have a gloss of from about 26 to about 34, about 26 to about 33, about 27 to about 32, about 26 to about 31, about 28 to about 32, or about 29 to about 33. The gloss of the film can be measured according to ASTM D2457-08.

The polyethylene can be blended and/or coextruded with any other polymer. Non-limiting examples of other polymers include linear low density polyethylenes, elastomers, plastomers, high pressure low density polyethylene, high density polyethylenes, polypropylenes, and the like.

The polyethylene can be blended or compounded with one or more additives. Illustrative additives can include, but are not limited to, tackifiers, antioxidants, nucleating agents, acid scavengers, plasticizers, stabilizers, anticorrosion agents, blowing agents, other ultraviolet light absorbers such as chain-breaking antioxidants, quenchers, antistatic agents, slip agents, pigments, dyes and fillers and cure agents such as peroxide. These and other common additives in the polyolefin industry can be present in polyethylene in an amount from a low of about 0.001 wt %, about 0.1 wt %, or about 1 wt % to a high of about 5 wt %, about 20 wt %, or about 50 wt %, based on the total weight of the polyethylene composition.

Illustrative tackifiers include any known tackifier effective in providing and/or improving cling force such as, for example, polybutenes, polyisobutylenes (PIB), polyterpenes, amorphous polypropylene, ethylene vinyl acetate copolymers, microcrystalline wax, alkali metal sulfosuccinates, and mono- and di-glycerides of fatty acids, such as glycerol monostearate, glycerol monooleate, sorbitan monolaurate, sorbitan monopalmitate, sorbitan monostearate, sorbitan monooleate, and any combination thereof. In at least one specific embodiment, the polyethylene can be mixed, blended, or otherwise combined with one or more polybutenes and/or polyisobutylenes (PIB).

The tackifier, if used, can be present in any amount that can provide a desired cling force in an end product, e.g., a cling film or a stretch cling film. The amount of tackifier combined with the polyethylene can be from about 0.1 wt % to about 20 wt % or about 0.25 wt % to about 6.0 wt %, based on the combined weight of the tackifer and the polyethylene. For example, the tackifier can be combined with the polyethylene in an amount from a low of about 0.1 wt %, about 0.5 wt %, about 1 wt %, about 1.3 wt %, about 1.5 wt %, or about 1.7 wt % to a high of about 2 wt %, about 2.5 wt %, about 3 wt %, about 3.5 wt %, about 4 wt %, about 4.5 wt %, or about 5 wt %, based on the combined weight of the tackifier and the polyethylene. Tackifier(s) can be used in monolayer films or in multi-layer films. In multiple layer films, one or more tackifiers can be added to both outer layers to provide a stretch film having two-sided cling, or in only one outer layer, to provide a stretch film having one-sided cling.

In particular, antioxidants and stabilizers such as organic phosphites and phenolic antioxidants can be present in the polyethylene composition in an amount from a low of about 0.001 wt %, about 0.01 wt %, or about 0.02 wt % to a high of about 0.5 wt %, about 0.8 wt %, or about 5 wt %. Non-limiting examples of organic phosphites that are suitable are tris(2,4-di-tert-butylphenyl)phosphite (IRGAFOS 168) and tris (nonyl phenyl) phosphite (WESTON 399) Non-limiting examples of phenolic antioxidants include octadecyl 3,5 di-t-butyl-4-hydroxyhydrocinnamate (IRGANOX 1076) and pentaerythrityl tetrakis(3,5-di-tert-butyl-4-hydroxyphenyl) propionate (IRGANOX 1010); and 1,3,5-Tri(3,5-di-tert-butyl-4-hydroxybenzyl-isocyanurate (IRGANOX 3114).

Fillers can be present in an amount from a low of about 0.1 wt %, about 0.5 wt %, or about 1 wt % to high of about 5 wt %, about 10 wt %, about 20 wt %, about 30 wt %, about 40 wt %, or about 50 wt %. Desirable fillers can include, but are not limited to, titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, talc and hydrotalcite compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous and brominated flame retardants, antimony trioxide, silica, silicone, and blends thereof. These fillers can particularly include any other fillers and porous fillers and supports known in the art.

Fatty acid salts can also be present in the polyolefin compositions. Such salts can be present in an amount from a low of about 0.001 wt %, about 0.01 wt %, about 0.1 wt %, or about 0.5 wt % to a high of about 1 wt %, about 1.5 wt %, about 2 wt %, or about 3 wt %. Examples of fatty acid metal salts include lauric acid, stearic acid, succinic acid, stearyl lactic acid, lactic acid, phthalic acid, benzoic acid, hydroxystearic acid, ricinoleic acid, naphthenic acid, oleic acid, palmitic acid, and erucic acid, suitable metals including Li, Na, Mg, Ca, Sr, Ba, Zn, Cd, Al, Sn, Pb and so forth. Desirable fatty acid salts are selected from magnesium stearate, calcium stearate, sodium stearate, zinc stearate, calcium oleate, zinc oleate, and magnesium oleate.

With respect to the physical process of producing the blend of polyethylene and one or more additives, sufficient mixing can be carried out to assure that a uniform blend is formed prior to conversion into a finished product. The polyethylene can be in any physical form when used to blend with the one or more additives. In one embodiment, reactor granules, defined as the granules of polymer that are isolated from the polymerization reactor, can be blended with the additives. The reactor granules have an average diameter of from 10 μm to 5 mm, and from 50 μm to 10 mm in another embodiment. Alternately, the polyethylene can be in the form of pellets, such as, for example, having an average diameter of from 1 mm to 6 mm that can be formed from melt extrusion of the reactor granules.

One method of blending the additives with the polyethylene can include contacting the components in a tumbler or other physical blending means, the polyethylene can be in the form of reactor granules. This can then be followed, if desired, by melt blending in an extruder. Another method of blending the components can be to melt blend the polyethylene pellets with the additives directly in an extruder, BRABENDER or any other melt blending means.

The resultant polyethylene can be further processed by any suitable means such as by film blowing or casting and all methods of film formation to achieve, for example, uniaxial or biaxial orientation. These and other forms of suitable processing techniques are described in, for example, Plastics Processing (Radian Corporation, Noyes Data Corp. 1986). Those skilled in the art will be able to determine the appropriate procedure for blending of the polymers to balance the need for intimate mixing of the component ingredients with the desire for process economy. Common rheological properties, processing methods and end use applications of metallocene based polyolefins are discussed in, for example, 2 Metallocene-Based Polyolefins 400-554 (John Scheirs & W. Kaminsky, eds. John Wiley & Sons, Ltd. 2000).

The polymers produced and blends thereof are useful in such forming operations as film, sheet, and fiber extrusion and co-extrusion as well as blow molding, injection molding and rotary molding. Films include blown or cast films formed by coextrusion or by lamination useful as shrink films, cling films, stretch films, stretch cling films, sealing films, oriented films, snack packaging, heavy duty bags, grocery sacks, baked and frozen food packaging, medical packaging, industrial liners, membranes, etc. in food-contact and non-food contact applications. Said another way, the films can be prepared by any conventional technique known to those skilled in the art, such as for example, techniques utilized to prepare blown, extruded, and/or cast stretch and/or shrink films (including shrink-on-shrink applications).

In making films that include the polyethylene via a blown film process, a blow up ratio from about 2 to 4, a draw-down ratio from about 30 to about 110, and a die gap from about 30 mils to about 110 mils can be used. The blow up ratio can be from a low of about 2, about 2.25, or about 2.5 to a high of about 3.0, about 3.5, or about 4.0. The draw-down ratio can be from about 30 to about 45, about 60 to about 90, or about 110 to about 120. The die gap can be from about 30 mils to about 45 mils, about 60 mils to about 90 mils, or about 110 mils to about 120 mils.

Specific end use films can include, for example, stretch films. Illustrative stretch films or stretch-type films can include, but are not limited to, stretch cling films, stretch handwrap films, and machine stretch films. Other types of films can include, but are not limited to, shrink films, shrink wrap films, green house films, laminates, and laminate films. The term “stretch film” refers to films capable of stretching and applying a bundling force and includes films stretched at the time of application as well as “pre-stretched” films, i.e., films which are provided in a pre-stretched form for use without additional stretching. The films can be monolayer films or multilayer films.

Films made from or including the polyethylene, e.g., as a component in a blended polymer, can have any desired thickness. For example, the total thickness of a monolayer and/or multilayer film, where the monolayer or at least one layer of a multilayer film includes or contains the polyethylene can vary based, at least in part, on the particular end use application. A total film thickness can be from a low of about 10 μm, about 25 μm, or about 50 μm to a high of about 75 μm, or about 100 μm. Those skilled in the art will appreciate that the thickness of individual layers for multilayer films can be adjusted based on desired end use performance, polymer or copolymer employed, equipment capability and other factors.

To facilitate discussion of different multilayer film structures, the following notation is used herein. Each layer of a film is denoted “A” or “B”, where “B” indicates a film layer not containing the polyethylene discussed and described above or elsewhere herein and “A” indicates a film layer having the polyethylene discussed and described above or elsewhere herein. The “A” layer can include the polyethylene and/or the polyethylene blended with one or more other polymers. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner or core layer of the conventional polyethylene disposed between two outer, film layers of the present polyethylene would be denoted A/B/A′. Similarly, a five-layer film of alternating polyethylene/conventional layers would be denoted A/B/A′/B′/A″. Unless otherwise indicated, the left-to-right or right-to-left order of layers does not matter, nor does the order of prime symbols. For example, an A/B film is equivalent to a B/A film, and an A/A′/B/A″ film is equivalent to an A/B/A′/A″ film, for purposes described herein.

The relative thickness of each film layer is similarly denoted, with the thickness of each layer relative to a total film thickness of 100 (dimensionless) indicated numerically and separated by slashes; e.g., the relative thickness of an A/B/A′ film having A and A′ layers of 10 μm each and a B layer of 30 μm is denoted as 20/60/20. Exemplary conventional films can be as discussed and described in, for example, U.S. Pat. Nos. 6,423,420; 6,255,426; 6,265,055; 6,093,480; 6,083,611; 5,922,441; 5,907,943; 5,907,942; 5,902,684; 5,814,399; 5,752,362; 5,749,202; 7,235,607; 7,601,409; RE 38,658; RE 38,429; U.S. Patent Publication No. 2007/0260016; and WO Publication No. WO2005/065945.

For the various films described herein, the “B” layer can be formed of any material known in the art for use in multilayer films or in film-coated products. Thus, for example, the B layer can be formed of a polyethylene (homopolymer or copolymer) different from the polyethylene discussed and described above or elsewhere herein, and the polyethylene can be, for example, a VLDPE, LDPE, LLDPE, MDPE, HDPE, DPE, as well as other polyethylenes known in the art. Illustrative additional polymers that can be used as or in the B layer can include, but are not limited to, other polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Suitable polyolefins can include, but are not limited to, polymers comprising one or more linear, branched or cyclic C2 to C40 olefins, preferably polymers comprising propylene copolymerized with one or more C3 to C40 olefins, preferably a C3 to C20 alpha olefin, more preferably C3 to C10 alpha-olefins.

The polymer film can be a multilayer film with any of the following exemplary structures: (a) two-layer films, such as A/B and A/A′; (b) three-layer films, such as A/B/A′ and A/A′/A″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″ ″; and similar structures for films having six, seven, eight, nine, or any other number of layers. It should be appreciated that films having still more layers can be formed using the polyethylene, and such films are within the scope of the invention.

The polyethylene of the present disclosure can be more easily extruded into film products by cast or blown film processing techniques with lower motor load, higher throughput and/or reduced head pressure as compared to EXCEED resins (available from ExxonMobil Chemical Co.) of comparable melt index, comonomer type, and density. Such polyethylenes have, for a comparable MI, a higher weight average molecular weight and a broader MWD than does an EXCEED resin.

The phrase “catalyst system,” as used herein, can include one or more polymerization catalysts, activators, supports/carriers, or any combination thereof, and the terms “catalyst” and “catalyst system” are intended to be used interchangeably herein. The term “supported” as used herein refers to one or more compounds that are deposited on, contacted with, vaporized with, bonded to, or incorporated within, adsorbed or absorbed in, or on, a support or carrier. The terms “support” or “carrier” for purposes of this specification are used interchangeably and are any support material, preferably a porous support material, including inorganic or organic support materials. Non-limiting examples of inorganic support materials include inorganic oxides and inorganic chlorides. Other carriers include resinous support materials such as polystyrene, functionalized or crosslinked organic supports, such as polystyrene, divinyl benzene, polyolefins, or polymeric compounds, zeolites, talc, clays, or any other organic or inorganic support material and the like, or mixtures thereof.

The metallocene catalyst compounds can include the “half sandwich” and “full sandwich” compounds having one or more “Cp” ligands (cyclopentadienyl and ligands isolobal to cyclopentadienyl) bound to at least one hafnium metal atom, and one or more leaving groups bound to the at least one hafnium metal atom. Hereinafter, these compounds will be referred to as “metallocenes,” “metallocene catalyst components,” “hafnium-based metallocene,” “hafnocene,” or “hafnium catalyst.” The metallocene catalyst component can be supported on a support material and can be supported with or without another catalyst component. Useful metallocenes can include those discussed and described in U.S. Pat. Nos. 8,084,560 and 7,579,415.

The Cp ligands are one or more rings or ring system(s), at least a portion of which includes pi-bonded systems, such as cycloalkadienyl ligands and heterocyclic analogues. The ring(s) or ring system(s) typically comprise atoms selected from Groups 13 to 16 atoms. For example, the atoms that make up the Cp ligands can be selected from carbon, nitrogen, oxygen, silicon, sulfur, phosphorous, germanium, boron, aluminum, and any combination thereof, where carbon makes up at least 50% of the ring members. In another example, the Cp ligand(s) can be selected from substituted and unsubstituted cyclopentadienyl ligands and ligands isolobal to cyclopentadienyl, non-limiting examples of which include cyclopentadienyl, indenyl, fluorenyl and other structures. Further non-limiting examples of such ligands can include cyclopentadienyl, cyclopentaphenanthreneyl, indenyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7H-dibenzofluorenyl, indeno[1,2-9]anthrene, thiophenoindenyl, thiophenofluorenyl, hydrogenated versions thereof (e.g., 4,5,6,7-tetrahydroindenyl, or “H₄Ind”), substituted versions thereof (as described in more detail below), and heterocyclic versions thereof.

The metal atom “M” of the metallocene catalyst compound is Hafnium. The oxidation state of the metal atom, i.e., Hf, can be +2, +3, or +4. The groups bound to the Hf atom are such that the compounds described below in the formulas and structures are electrically neutral, unless otherwise indicated. The Cp ligand(s) form at least one chemical bond with the Hf atom to form the “metallocene catalyst compound.” The Cp ligands are distinct from the leaving groups bound to the catalyst compound in that they are not highly susceptible to substitution/abstraction reactions.

Useful metallocene catalyst components can include those represented by the formula (I):

Cp^{A}Cp^{B}MXₙ (I)

where M is Hf; each X is chemically bonded to M; each Cp group is chemically bonded to M; and n is 0 or an integer from 1 to 4, or either 1 or 2 in a particular exemplary embodiment. The ligands represented by Cp^{A} and Cp^{B} in formula (I) can be the same or different cyclopentadienyl ligands or ligands isolobal to cyclopentadienyl, either or both of which can contain heteroatoms and either or both of which can be substituted by a group R. For example, Cp^{A} and Cp^{B} can be independently selected from cyclopentadienyl, indenyl, tetrahydroindenyl, fluorenyl, and substituted derivatives of each.

Independently, each Cp^{A} and Cp^{B} of formula (I) can be unsubstituted or substituted with any one or combination of substituent groups R. Non-limiting examples of substituent groups R as used in structure (I) as well as ring substituents in structures (Va-d) include groups selected from hydrogen radicals, alkyls, alkenyls, alkynyls, cycloalkyls, aryls, acyls, aroyls, alkoxys, aryloxys, alkylthiols, dialkylamines, alkylamidos, alkoxycarbonyls, aryloxycarbonyls, carbamoyls, alkyl- and dialkyl-carbamoyls, acyloxys, acylaminos, aroylaminos, and combinations thereof. More particular non-limiting examples of alkyl substituents R associated with formulas (I) through (Va-d) include methyl, ethyl, propyl, butyl, pentyl, hexyl, cyclopentyl, cyclohexyl, benzyl, phenyl, methylphenyl, and tert-butylphenyl groups and the like, including all their isomers, for example, tertiary-butyl, isopropyl, and the like. Other possible radicals include substituted alkyls and aryls such as, for example, fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals, including tris(trifluoromethyl)silyl, methylbis(difluoromethyl)silyl, bromomethyldimethylgermyl and the like; and disubstituted boron radicals including dimethylboron, for example; and disubstituted Group 15 radicals including dimethylamine, dimethylphosphine, diphenylamine, methylphenylphosphine, as well as Group 16 radicals including methoxy, ethoxy, propoxy, phenoxy, methylsulfide and ethylsulfide. Other substituents R include, but are not limited to, olefins such as olefinically unsaturated substituents including vinyl-terminated ligands such as, for example, 3-butenyl, 2-propenyl, 5-hexenyl and the like. In some embodiments, at least two R groups (two adjacent R groups in a particular exemplary embodiment) are joined to form a ring structure having from 3 to 30 atoms selected from the group consisting of carbon, nitrogen, oxygen, phosphorous, silicon, germanium, aluminum, boron and combinations thereof. Also, a substituent group R group such as 1-butanyl can form a bonding association to the element M.

Each X in the formula (I) above and for the formulae/structures (II) through (Va-d) below can be any leaving group or can be independently selected from: halogen ions, hydrides, C1 to C12 alkyls, C2 to C12 alkenyls, C6 to C12 aryls, C7 to C20 alkylaryls, C1 to C12 alkoxys, C6 to C16 aryloxys, C7 to C18 alkylaryloxys, C1 to C12 fluoroalkyls, C6 to C12 fluoroaryls, and C1 to C12 heteroatom-containing hydrocarbons and substituted derivatives; or can be selected from hydride, halogen ions, C1 to C6 alkyls, C2 to C6 alkenyls, C7 to C18 alkylaryls, C1 to C6 alkoxys, C6 to C14 aryloxys, C7 to C16 alkylaryloxys, C1 to C6 alkylcarboxylates, C1 to C6 fluorinated alkylcarboxylates, C6 to C12 arylcarboxylates, C7 to C18 alkylarylcarboxylates, C1 to C6 fluoroalkyls, C2 to C6 fluoroalkenyls, and C7 to C18 fluoroalkylaryls; or can be selected from hydride, chloride, fluoride, methyl, phenyl, phenoxy, benzoxy, tosyl, fluoromethyls and fluorophenyls; or can be selected from C1 to C12 alkyls, C2 to C12 alkenyls, C6 to C12 aryls, C7 to C20 alkylaryls, substituted C1 to C12 alkyls, substituted C6 to C12 aryls, substituted C7 to C20 alkylaryls and C1 to C12 heteroatom-containing alkyls, C1 to C12 heteroatom-containing aryls and C1 to C12 heteroatom-containing alkylaryls; or can be selected from chloride, fluoride, C1 to C6 alkyls, C2 to C6 alkenyls, C7 to C18 alkylaryls, halogenated C1 to C6 alkyls, halogenated C2 to C6 alkenyls, and halogenated C7 to C18 alkylaryls; or can be selected from fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls); or can be fluoride in some embodiments.

Other non-limiting examples of X groups can include amines, phosphines, ethers, carboxylates, dienes, hydrocarbon radicals having from 1 to 20 carbon atoms, fluorinated hydrocarbon radicals (e.g., —C₆F₅ (pentafluorophenyl)), fluorinated alkylcarboxylates (e.g., CF₃C(O)O—), hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, dimethylphosphide radicals and the like. In some embodiments, two or more X's can form a part of a fused ring or ring system.

Other useful metallocene catalyst components can include those of formula (I) where Cp^{A} and Cp^{B} are bridged to each other by at least one bridging group, (A), such that the structure is represented by formula (II):

Cp^{A}(A)Cp^{B}MXₙ (II)

These bridged compounds represented by formula (II) are known as “bridged metallocenes.” The elements Cp^{A}, Cp^{B}, M, X and n in structure (II) are as defined above for formula (I); where each Cp ligand, i.e., Cp^{A} and Cp^{B}, is chemically bonded to M, and (A) is chemically bonded to each Cp. Non-limiting examples of bridging group (A) include divalent hydrocarbon groups containing at least one Group 13 to 16 atom, such as at least one of a carbon, oxygen, nitrogen, silicon, aluminum, boron, germanium and tin atom and combinations thereof; where the heteroatom can also be C1 to C12 alkyl or aryl substituted to satisfy neutral valency. The bridging group (A) can also contain substituent groups R as defined above (for formula (I)) including halogen radicals and iron. More particular non-limiting examples of bridging group (A) are represented by C1 to C6 alkylenes, substituted C1 to C6 alkylenes, oxygen, sulfur, R′₂C═, R′₂Si═, ═Si(R′)₂Si(R′₂)═, R′₂Ge═, and R′P═ (where “═” represents two chemical bonds), where R′ is independently selected from hydride, hydrocarbyl, substituted hydrocarbyl, halocarbyl, substituted halocarbyl, hydrocarbyl-substituted organometalloid, halocarbyl-substituted organometalloid, disubstituted boron, disubstituted Group 15 atoms, substituted Group 16 atoms, and halogen radical; and where two or more R′ can be joined to form a ring or ring system. In some embodiments, the bridged metallocene catalyst component of formula (II) has two or more bridging groups (A).

Other non-limiting examples of bridging group (A) can include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties where the Si atom is replaced by a Ge or a C atom; as well as dimethylsilyl, diethylsilyl, dimethylgermyl and diethylgermyl.

In some embodiments, bridging group (A) can also be cyclic, having, for example, 4 to 10 ring members, or 5 to 7 ring members. The ring members can be selected from the elements mentioned above, and, in some embodiments, are selected from one or more of B, C, Si, Ge, N and O. Non-limiting examples of ring structures which can be present as, or as part of, the bridging moiety are cyclobutylidene, cyclopentylidene, cyclohexylidene, cycloheptylidene, cyclooctylidene and the corresponding rings where one or two carbon atoms are replaced by at least one of Si, Ge, N and O. In some embodiments, one or two carbon atoms are replaced by at least one of Si and Ge. The bonding arrangement between the ring and the Cp groups can be either cis-, trans-, or a combination.

The cyclic bridging groups (A) can be saturated or unsaturated and/or can carry one or more substituents and/or can be fused to one or more other ring structures. If present, the one or more substituents can be selected from hydrocarbyl (e.g., alkyl, such as methyl) and halogen (e.g., F and Cl). The one or more Cp groups to which the above cyclic bridging moieties can optionally be fused can be saturated or unsaturated, and can be selected from those having 4 to 10, or more particularly 5, 6, or 7 ring members (selected from C, N, O and S in some embodiments), such as, for example, cyclopentyl, cyclohexyl, and phenyl. Moreover, these ring structures can themselves be fused such as, for example, in the case of a naphthyl group. Moreover, these (optionally fused) ring structures can carry one or more substituents. Illustrative, non-limiting examples of these substituents are hydrocarbyl (particularly alkyl) groups and halogen atoms.

Useful metallocene catalyst components can also include bridged mono-ligand metallocene compounds (e.g., mono cyclopentadienyl catalyst components). In these embodiments, the at least one metallocene catalyst component is a bridged “half-sandwich” metallocene represented by formula (III):

Cp^{A}(A)QMXᵣ (III)

where Cp^{A}, (A), M, and X in structure (III) are is as defined above with regard to formulas I and II. Cp^{A} is bound to M, (A) is a bridging group bonded to Q and Cp^{A}, and an atom from the Q group is bonded to M, and r is 0 or an integer selected from 1 or 2. In formula (III) above, Cp^{A}, (A) and Q can form a fused ring system. In one exemplary embodiment, Cp^{A} is selected from cyclopentadienyl, indenyl, tetrahydroindenyl, fluorenyl, substituted versions thereof, and combinations thereof.

In formula (III), Q is a heteroatom-containing ligand in which the bonding atom (the atom that is bonded with the metal M) can be selected from Group 15 atoms and Group 16 atoms. For example, the bonding atom can be selected from nitrogen, phosphorus, oxygen or sulfur atoms, or can be selected from nitrogen and oxygen. Non-limiting examples of Q groups include alkylamines, arylamines, mercapto compounds, ethoxy compounds, carboxylates (e.g., pivalate), carbamates, azenyl, azulene, pentalene, phosphoyl, phosphinimine, pyrrolyl, pyrozolyl, carbazolyl, borabenzene other compounds having Group 15 and Group 16 atoms capable of bonding with M.

Useful metallocene catalyst components can include unbridged “half sandwich” metallocenes represented by the formula (IVa):

Cp^{A}MQ_{q}X_{w} (IVa)

where Cp^{A}, M, Q, and X are as defined above for formulas (I-III). Cp^{A} is a ligand that is bonded to M; each Q is independently bonded to M; w ranges from 0 to 3, or is 0 or 3; and q ranges from 0 to 3, or is 0 or 3. In formula (IVa), Cp^{A} can be selected from cyclopentadienyl, indenyl, tetrahydroindenyl, fluorenyl, substituted versions thereof, and combinations thereof. In formula (IVa), Q can be selected from ROO—, RO—, R(O)—, —NR—, —CR₂—, —S—, —NR₂, —CR₃, —SR, —SiR₃, —PR₂, —H, and substituted and unsubstituted aryl groups, R can be selected from C1 to C6 alkyls, C6 to C12 aryls, C1 to C6 alkylamines, C6 to C12 alkylarylamines, C1 to C6 alkoxys, C6 to C12 aryloxys, and the like. Non-limiting examples of Q include C1 to C12 carbamates, C1 to C12 carboxylates (e.g., pivalate), C2 to C20 allyls, and C2 to C20 heteroallyl moieties.

Described another way, the “half sandwich” metallocenes above can be described as in formula (IVb), such as described in, for example, U.S. Pat. No. 6,069,213:

Cp^{A}M(W₂GZ)X_{y} or

T(Cp^{A}M(W₂GZ)X_{y})ₘ (IVb)

where M, Cp^{A}, and X are as defined above; W₂GZ forms a polydentate ligand unit (e.g., pivalate), where at least one of the W groups form a bond with M, and is defined such that each W is independently selected from —O—, —NR—, —CR₂— and —S—; G is either carbon or silicon; and Z is selected from R, —OR, —NR₂, —CR₃, —SR, —SiR₃, —PR₂, and hydride, providing that when W is —NR—, then Z is selected from —OR, —NR₂, —SR, —SiR₃, —PR₂; and provided that neutral valency for W is satisfied by Z; and where each R is independently selected from C1 to C10 heteroatom containing groups, C1 to C10 alkyls, C6 to C12 aryls, C6 to C12 alkylaryls, C1 to C10 alkoxys, and C6 to C12 aryloxys; y is 1 or 2; T is a bridging group selected from C1 to C10 alkylenes, C6 to C12 arylenes and C1 to C10 heteroatom containing groups, and C6 to C12 heterocyclic groups; where each T group bridges adjacent “Cp^{A}M(W₂GZ)Xy” groups, and is chemically bonded to the Cp^{A} groups; and m is an integer from 1 to 7, or is an integer from 2 to 6.

Useful metallocene catalyst components can also include those described more particularly in structures (Va), (Vb), (Vc) and (Vd):

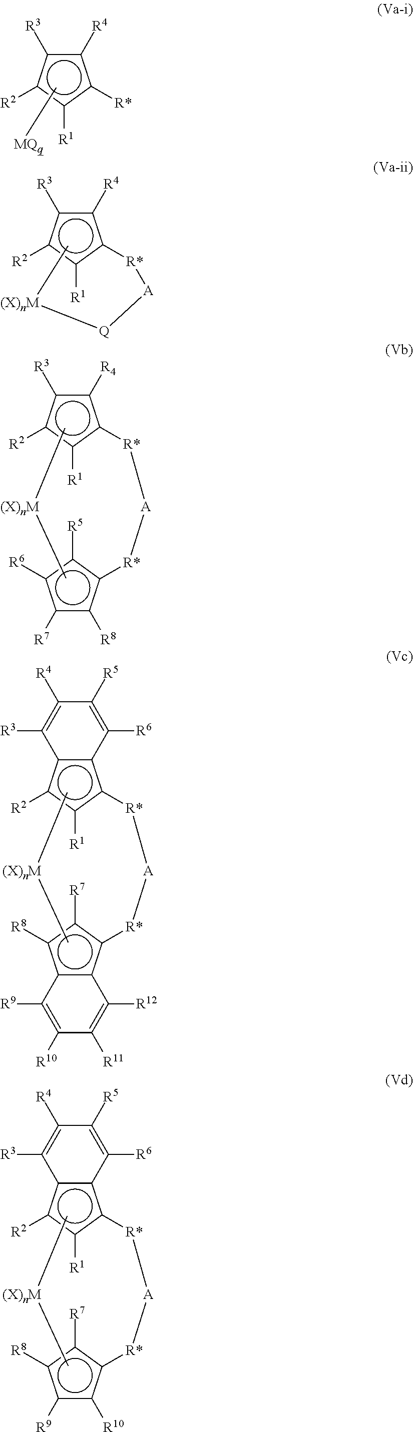

where in structures (Va) to (Vd) M is hafnium; where Q in (Va-i) and (Va-ii) is selected from halogen ions, alkyls, alkylenes, aryls, arylenes, alkoxys, aryloxys, amines, alkylamines, phosphines, alkylphosphines, substituted alkyls, substituted aryls, substituted alkoxys, substituted aryloxys, substituted amines, substituted alkylamines, substituted phosphines, substituted alkylphosphines, carbamates, heteroallyls, carboxylates (non-limiting examples of suitable carbamates and carboxylates include trimethylacetate, trimethylacetate, methylacetate, p-toluate, benzoate, diethylcarbamate, and dimethylcarbamate), fluorinated alkyls, fluorinated aryls, and fluorinated alkylcarboxylates; where q is an integer ranging from 1 to 3; where each R* is independently: selected from hydrocarbyls and heteroatom-containing hydrocarbyls, or is selected from alkylenes, substituted alkylenes and heteroatom-containing hydrocarbyls embodiment, or is selected from C1 to C12 alkylenes, C1 to C12 substituted alkylenes, and C1 to C12 heteroatom-containing hydrocarbons, or is selected from C1 to C4 alkylenes; and where both R* groups are identical in some embodiments in structures (Vb-d); A is as described above for (A) in structure (11), and more particularly, selected from —O—, —S—, —SO₂—, —NR—, ═SiR₂, ═GeR₂, ═SnR₂, —R₂SiSiR₂—, RP═, C1 to C12 alkylenes, substituted C1 to C12 alkylenes, divalent C4 to C12 Cyclic hydrocarbons and substituted and unsubstituted aryl groups, or is selected from C5 to C8 cyclic hydrocarbons, —CH2CH2-, ═CR₂ and ═SiR₂; where R is selected from alkyls, cycloalkyls, aryls, alkoxys, fluoroalkyls, and heteroatom-containing hydrocarbons, or R is selected from C1 to C6 alkyls, substituted phenyls, phenyl, and C1 to C6 alkoxys, or R is selected from methoxy, methyl, phenoxy, and phenyl; where A can be absent in some embodiments, in which case each R* is defined as for R1-R12; each X is as described above in (1); n is an integer from 0 to 4, or from 1 to 3, or is 1 or 2; and R1 through R12 are independently selected from hydrogen radical, halogen radicals, C1 to C12 alkyls, C2 to C12 alkenyls, C6 to C12 aryls, C7 to C20 alkylaryls, C1 to C12 alkoxys, C6 to C12 fluoroalkyls, C6 to C12 fluoroaryls, and C1 to C12 heteroatom-containing hydrocarbons and substituted derivatives thereof, or are selected from hydrogen radical, fluorine radical, chlorine radical, bromine radical, C1 to C6 alkyls, C2 to C6 alkenyls, C7 to C18 alkylaryls, C1 to C6 fluoroalkyls, C2 to C6 fluoroalkenyls, and C7 to C18 fluoroalkylaryls; or are selected from hydrogen radical, fluorine radical, chlorine radical, methyl, ethyl, propyl, isopropyl, butyl, isobutyl, tertiary butyl, hexyl, phenyl, 2,6-di-methylphenyl, and 4-tertiarybutylphenyl groups; where adjacent R groups can form a ring, either saturated, partially saturated, or completely saturated.

The structure of the metallocene catalyst component represented by (Va) can take on many forms, such as those described in, for example, U.S. Pat. Nos. 5,026,798; 5,703,187; and 5,747,406, including a dimer or oligomeric structure, such as described in, for example, U.S. Pat. Nos. 5,026,798 and 6,069,213.

In some embodiments of the metallocene represented in (Vd), R₁ and R₂ form a conjugated 6-membered carbon ring system that may or may not be substituted.

Useful metallocene catalyst components can be selected from, but are not limited to, bis(n-propylcyclopentadienyl)hafnium Xₙ, bis(n-butylcyclopentadienyl)hafnium Xₙ, bis(n-pentylcyclopentadienyl)hafnium Xₙ, (n-propyl cyclopentadienyl)(n-butyl cyclopentadienyl)hafnium Xₙ, bis[(2-trimethylsilylethyl)cyclopentadienyl]hafnium Xₙ, bis(trimethylsilyl cyclopentadienyl)hafnium Xₙ, bis(2-n-propylindenyl)hafnium Xₙ, bis(2-n-butylindenyl)hafnium Xₙ, dimethylsilylbis(n-propylcyclopentadienyl)hafnium Xₙ, dimethylsilylbis(n-butylcyclopentadienyl)hafnium Xₙ, bis(9-n-propylfluorenyl)hafnium Xₙ, bis(9-n-butylfluorenyl)hafnium Xₙ, (9-n-propylfluorenyl)(2-n-propylindenyl)hafnium Xₙ, bis(1-n-propyl-2-methylcyclopentadienyl)hafnium Xₙ, (n-propylcyclopentadienyl)(1-n-propyl-3-n-butylcyclopentadienyl)hafnium Xₙ, and derivatives thereof, where the value of n is 1, 2, or 3. The phrase “derivatives thereof” will be understood to mean any substitution or ring formation as described above for structures (Va-d) in one exemplary embodiment; and replacement of the “X” group with any of C1 to C5 alkyls, C6 aryls, C6 to C10 alkylaryls, fluorine, chlorine, or bromine in one other exemplary embodiment.

In one or more embodiments, the metallocene catalyst can be bis(n-propylcyclopentadienyl)hafnium Xₙ, bis(n-butylcyclopentadienyl)hafnium Xₙ, bis(n-pentylcyclopentadienyl)hafnium Xₙ, (n-propyl cyclopentadienyl)(n-butylcyclopentadienyl)hafnium Xₙ, bis[(2-trimethylsilylethyl)cyclopentadienyl]hafnium Xₙ, bis(trimethylsilyl cyclopentadienyl)hafnium Xₙ, dimethylsilylbis(n-propylcyclopentadienyl)hafnium Xₙ, dimethylsilylbis(n-butylcyclopentadienyl)hafnium Xₙ, bis(1-n-propyl-2-methylcyclopentadienyl)hafnium Xₙ, (n-propylcyclopentadienyl)(1-n-propyl-3-n-butylcyclopentadienyl)hafnium Xₙ, or any mixture thereof, where Xₙ is as discussed and described above. In other embodiments, the metallocene catalyst can be a bis(n-propylcyclopentadienyl)hafnium dichloride, a bis(n-propylcyclopentadienyl)hafnium difluoride, or a dimethyl bis(n-propylcyclopentadienyl)hafnium.

It is contemplated that the metallocene catalysts components described above include their structural or optical or enantiomeric isomers (racemic mixture), and, in some embodiments, can be a pure enantiomer.

As used herein, a single, bridged, asymmetrically substituted metallocene catalyst component having a racemic and/or meso isomer does not, itself, constitute at least two different bridged, metallocene catalyst components.

The catalyst systems discussed and described herein can include one or more activators. The term “activator” is defined to be any compound or component which can activate a bulky ligand transition metal metallocene-type catalyst compound as described above. For example, a Lewis acid or a non-coordinating ionic activator or ionizing activator or any other compound that can convert a neutral metallocene catalyst component to a metallocene cation. Useful activators can include alumoxane or modified alumoxane, or ionizing activators, neutral or ionic, such as tri (n-butyl) ammonium tetrakis(pentafluorophenyl) boron or a trisperfluorophenyl boron metalloid precursor which ionize the neutral metallocene compound can also be used. A preferred activator used with the catalyst compositions described herein is methylaluminoxane (“MAO”). The MAO activator can be associated with or bound to a support, either in association with the catalyst component (e.g., metallocene) or separate from the catalyst component, such as described by Gregory G. Hlatky, Heterogeneous Single-Site Catalysts for Olefin Polymerization, 100(4) CHEMICAL REVIEWS 1347-1374 (2000).

There are a variety of methods for preparing alumoxane and modified alumoxanes, non-limiting examples of which are described in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081; 5,157,137; 5,103,031; 5,391,793; 5,391,529; 5,693,838 and European Patent No.: EP0279586B1; European Publication Nos.: EP0561476A and EPA0594218A; and WO Publication No.: WO 94/10180.

Ionizing compounds can contain an active proton, or some other cation associated with but not coordinated or only loosely coordinated to the remaining ion of the ionizing compound. Such compounds and the like are described in European Publication Nos.: EP0570982A; EP0520732A; EP0495375A; EP0426637A; EP0500944A; EP0277003A; and EP0277004A; and U.S. Pat. Nos. 5,153,157; 5,198,401; 5,066,741; 5,206,197; 5,241,025; 5,387,568; 5,384,299; and 5,502,124.

Combinations of activators are also contemplated, for example, alumoxanes and ionizing activators in combination, see for example, WO Publication Nos.: WO 94/07928 and WO 95/14044 and U.S. Pat. Nos. 5,153,157 and 5,453,410.

As noted above, supports can be present as part of the catalyst system. Supports, methods of supporting, modifying, and activating supports for single-site catalyst such as metallocenes are discussed in, for example, 1 METALLOCENE-BASED POLYOLEFINS 173-218 (J. Scheirs & W. Kaminsky eds., John Wiley & Sons, Ltd. 2000). The terms “support” or “carrier,” as used herein, are used interchangeably and refer to any support material, including inorganic or organic support materials. In some embodiments, the support material can be a porous support material. Non-limiting examples of support materials include inorganic oxides and inorganic chlorides, and in particular such materials as talc, clay, silica, alumina, magnesia, zirconia, iron oxides, boria, calcium oxide, zinc oxide, barium oxide, thoria, aluminum phosphate gel, and polymers such as polyvinylchloride and substituted polystyrene, functionalized or crosslinked organic supports such as polystyrene divinyl benzene polyolefins or polymeric compounds, and mixtures thereof, and graphite, in any of its various forms.

Desirable supports are inorganic oxides that include Group 2, 3, 4, 5, 13, and 14 oxides and chlorides. Support materials can include silica, alumina, silica-alumina, magnesium chloride, graphite, and mixtures thereof. Other useful supports include magnesia, titania, zirconia, montmorillonite (as described in EP Patent No.: EP0511665B1), phyllosilicate, and the like. In some embodiments, combinations of the support materials can be used, including, but not limited to, combinations such as silica-chromium, silica-alumina, silica-titania, and the like. Additional support materials can include those porous acrylic polymers described in EP Patent No.: EP0767184B1.

Examples of supporting a catalyst system are described in U.S. Pat. Nos. 4,701,432; 4,808,561; 4,912,075; 4,925,821; 4,937,217; 5,008,228; 5,238,892; 5,240,894; 5,332,706; 5,346,925; 5,422,325; 5,466,649; 5,466,766; 5,468,702; 5,529,965; 5,554,704; 5,629,253; 5,639,835; 5,625,015; 5,643,847; 5,665,665; 5,468,702; and 6,090,740; and WO Publication Nos.: WO 95/32995; WO 95/14044; WO 96/06187; and WO 97/02297.

In some embodiments, the catalyst system contains a polymer bound ligand as described in U.S. Pat. No. 5,473,202. In some embodiments, the support can be functionalized as described in European Publication No.: EP0802203A or at least one substituent or leaving group is selected as described in U.S. Pat. No. 5,688,880.

The catalyst system can be spray dried as described in U.S. Pat. No. 5,648,310 after which the dried catalyst system is contacted with the selected liquid agent to saturate the pores of the catalyst.

In some embodiments, the supported catalyst can be produced by a method where the selected liquid agent is used as a solvent during manufacture of the catalyst or the solvent used during manufacture of the catalyst is displaced with the selected liquid agent.

In other embodiments, the supported catalyst systems can include an antistatic agent or surface modifier, for example, those described in U.S. Pat. No. 5,283,278 and WO Publication No.: WO 96/11960.

### Polymerization Process

The catalysts discussed and described above can be used in any olefin prepolymerization and/or polymerization process. Suitable polymerization processes include solution, gas phase, slurry phase and a high pressure process, or any combination thereof. A desirable process is the gas phase polymerization of ethylene or ethylene and one or more comonomers.

Hydrogen gas can be present during polymerization of the ethylene or the ethylene and the one or more comonomers to control the final properties of the polyolefin, such as described in Polypropylene Handbook 76-78 (Hanser Publishers, 1996). Increasing concentrations (partial pressures) of hydrogen can increase the melt index ratio (MIR) or melt flow rate (MFR) and/or melt index (MI) of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and hexane or propylene. The amount of hydrogen used in the polymerization process of the polyethylene can be sufficient to produce the desired MI, FI, and/or MIR of the final polyolefin resin. In one embodiment, the mole ratio of hydrogen to total monomer (H₂:monomer) is in a range of from greater than 0.0001 in one embodiment, and from greater than 0.0005 in another embodiment, and from greater than 0.001 in yet another embodiment, and less than 10 in yet another embodiment, and less than 5 in yet another embodiment, and less than 3 in yet another embodiment, and less than 0.10 in yet another embodiment, where a desirable range can comprise any combination of any upper mole ratio limit with any lower mole ratio limit described herein. Expressed another way, the amount of hydrogen in the reactor at any time can range to up to 5,000 ppm, and up to 4,000 ppm in another embodiment, and up to 3,000 ppm in yet another embodiment, and between 50 ppm and 5,000 ppm in yet another embodiment, and between 100 ppm and 2,000 ppm in another embodiment.

Typically in a gas phase polymerization process a continuous cycle is employed where one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer.

Further, it is common to use a staged reactor employing two or more reactors in series, where one reactor can produce, for example, a high molecular weight component and another reactor can produce a low molecular weight component. In one embodiment of the invention, the polyolefin is produced using a staged gas phase reactor. This and other commercial polymerization systems are described in, for example, 2 Metallocene-Based Polyolefins 366-378 (John Scheirs & W. Kaminsky, eds. John Wiley & Sons, Ltd. 2000). Gas phase processes contemplated by the invention include those described in U.S. Pat. Nos. 5,627,242; 5,665,818; and U.S. Pat. No. 5,677,375; European Patent Nos.: EP0649992B1 and EP0634421B1; and European Publication Nos.: EP0794200A; EP0802202A.

### EXAMPLES

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

### Example I

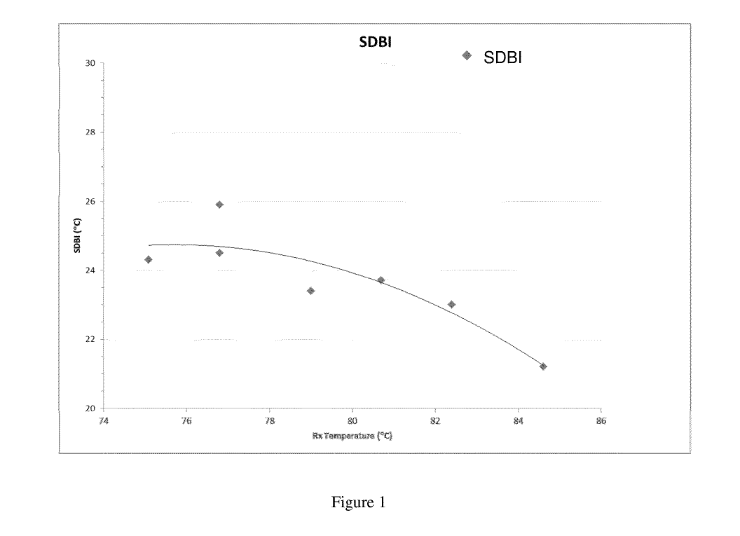

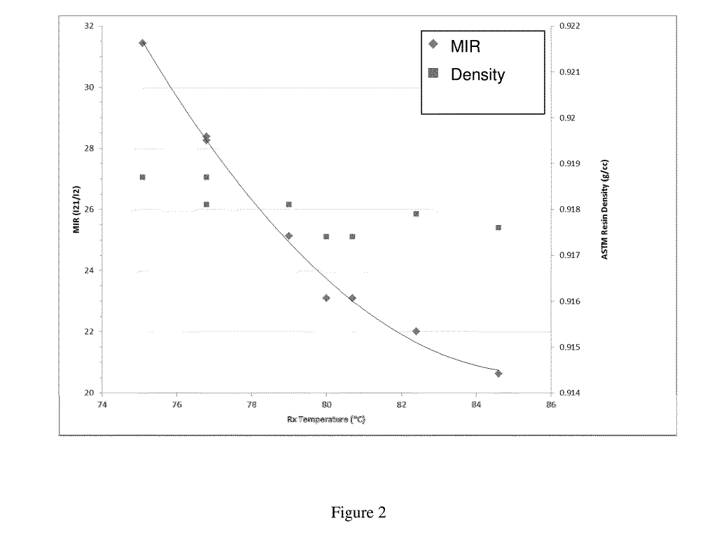

A series of ethylene/hexene copolymers (Ex. 1-7) were produced at different polymerization temperatures, i.e., 74° C. to 84° C. at 2° C. intervals, and the solubility distribution breadth index (SDBI) was measured. A graphical representation of the SDBI values for the polyethylene polymers versus polymerization temperature is depicted in FIG. 1. The melt index ratio (MIR) was also determined for each of Examples 1-7 and a graphical representation of the MIR values for the polyethylene polymers versus polymerization temperature is depicted in FIG. 2.

### Catalyst Preparation

The metallocene catalyst used to produce the ethylene polymers of Examples 1 to 7 was Bis(propylcyclopentadienyl)hafnium dimethyl, (PrCp)₂Hf(CH₃)₂, which was purchased from Boulder Scientific Co. The active catalyst was prepared with 4.7 mmol Al/g of support and 0.058 mmol Hf/g of catalyst. Methylaluminoxane (MAO) (30 wt % solution in toluene obtained from Albemarle Corporation, Baton Rouge, La.) and the metallocene were added to the reactor first and mixed for half an hour at room temperature. In a high temperature fluidized bed activator, Siral 40 silica alumina catalyst support available from Sasol Corporation was combined with ammonium hexafluorosilicate [(NH₄)₂SiF₆] available from KC Industries at the ratio of 0.11 lb ammonium hexafluorosilicate per lb of raw Siral 40 silica alumina. This was then fluidized with about 0.1 ft/sec superficial gas velocity of nitrogen while heating up to about 200° C., then fluidized with about 0.1 to 0.24 ft/sec superficial gas velocity of air while heating up to about 650° C., and held at 650° C. for about 5 hours in air. The product was then cooled to ambient temperature, purged with nitrogen to remove air, and discharged inertly. The fluorided and dehydrated support was then added directly into the MAO/metallocene solution, and mixed for an additional one hour at room temperature. The catalysts were then dried under vacuum until the internal temperature was lined out at approximately 70° C. for 3 hours.

### Polymer Production

Using the catalyst system described above, ethylene/hexene copolymers of Examples 1-7 were produced according to the reaction conditions listed in Table 1.

TABLE 1
Polymerization Conditions

| Examples | 1 | 2 | 3 | 4 | 5 | 6 | 7 |
|---|---|---|---|---|---|---|---|
| Production | 152 | 139 | 148 | 158 | 145 | 140 | 148 |
| Rate (lb/hr) | | | | | | | |
| Hydrogen | 319 | 315 | 320 | 316 | 329 | 329 | 330 |
| (ppm) | | | | | | | |
| C₂ partial | 220 | 220 | 220 | 220 | 220 | 219 | 220 |
| pres. (psia) | | | | | | | |
| C₆/C₂ ratio | 0.098 | 0.096 | 0.098 | 0.095 | 0.092 | 0.089 | 0.085 |
| Temp. (° C.) | 74 | 76 | 76 | 78 | 80 | 82 | 84 |
| Res. Time | 4.6 | 5.0 | 4.7 | 4.4 | 4.8 | 5.0 | 4.7 |
| (hr) | | | | | | | |

The ethylene and hexene was polymerized in a 22.5 inch diameter gas-phase fluidized bed reactor operating at approximately 314 psig total pressure. The reactor bed weight was approximately 695 pounds. Fluidizing gas was passed through the bed at a velocity of approximately 2.25 feet per second. The fluidizing gas exiting the bed entered a resin disengaging zone located at the upper portion of the reactor. The fluidizing gas then entered a recycle loop and passed through a cycle gas compressor and water-cooled heat exchanger. The shell side water temperature was adjusted to maintain the reaction temperature to the specified value. Ethylene, hydrogen, 1-hexene and nitrogen were fed to the cycle gas loop just upstream of the compressor at quantities sufficient to maintain the desired gas concentrations. Gas concentrations were measured by an on-line vapor fraction analyzer. The catalyst was fed dry or as a mineral oil slurry (17 wt % solids) to the reactor bed through a stainless steel injection tube at a rate sufficient to maintain the desired polymer production rate. Nitrogen gas was used to disperse the catalyst into the reactor. Product was withdrawn from the reactor in batch mode into a purging vessel before it was transferred into a product drum. Residual catalyst and cocatalyst in the resin was deactivated in the product drum with a wet nitrogen purge.

Blown films were extruded on a 2.5″ Battenfield Gloucester line (30:1 L:D) equipped with a 6″ oscillating die. Output rate was 188 lb/hr (10 lb/hr/in die circumference) and the die gap was 60 mil. The target film gauge was 1.0 mil and BUR was held constant at 2.5. The frost-line height (FLH) was between 19-24″. A standard “hump” temperature profile was used where “BZ” is barrel zone: BZ1=310° F./BZ2=410° F./BZ3=375° F./BZ4=335° F./BZ5=335° F./Adapter=390° F./Die=390° F.

As shown in FIG. 1, the SDBI for the ethylene polymers decreased as the polymerization temperature increased. The cling value for a film made with the polyethylene of Example 7 showed a significant improvement in cling and the rate of cling development as compared to Example 1.

The SDBI values for Examples 1-7 were measured using an analytical size TREF instrument (Polymer Char, Spain), with a column that had the following dimension: inner diameter (ID) 7.8 mm and outer diameter (OD) 9.53 mm and a column length of 150 mm. The column was filled with steel beads. To the column was introduced 0.5 mL of a 6.4% (w/v) polymer solution for each example in orthodichlorobenzene (ODCB) containing 6 g BHT/4 L was introduced into the column and cooled from 140° C. to 0° C. at a constant cooling rate of 1.0° C./min. Subsequently, ODCB was pumped through the column at a flow rate of 1.0 ml/min, and the column temperature was increased at a constant heating rate of 2° C./min to elute the polymer. The polymer concentration in the eluted liquid was detected by means of measuring the absorption at a wavenumber of 2857 cm⁻¹ using an infrared detector. The concentration of the ethylene-α-olefin copolymer in the eluted liquid was calculated from the absorption and plotted as a function of temperature. The reported SDBI values were calculated using the commercial software from Polymer Char.

As shown in FIG. 2, the MIR decreased as the polymerization temperature increased. Accordingly, the film that exhibited the increased cling values (Example 7) had a reduced SDBI value and a reduced MIR value.

The cling value for the polyethylene films made in Examples 1 and 7 were measured and are discussed in more detail below in Example II.

### Example II

A set of polyethylene films (Ex. 1 and 7 from above and comparative examples C1 and C2) were prepared and the rate of cling development after forming the film was monitored. The polyethylene film of comparative example C1 was made from EXCEED 1018CA, a commercially available mLLDPE from ExxonMobil Chemical Company. The polyethylene film of comparative example C2 was made from ELITE 5400G, a commercially available mLLDPE from The Dow Chemical Company. The EXCEED 1018CA and ELITE 5400G are the conventional polyethylenes used to produce blown films. The polymers of comparative examples C1 and C2 were not prepared with a hafnium containing catalyst.

The properties for the polyethylene used in Examples 1 and 7 and comparative examples C1 and C2 are shown in Table 2 below.

TABLE 2
Polyethylene Properties

| | Ex. 1 | Ex. 7 | C1 | C2 | Test Method |
|---|---|---|---|---|---|
| MI (I₂) | 1.08 | 0.98 | 0.93 | 0.98 | ASTM D-1238 |
| | | | | | (190° C., 2.16 kg) |
| FI (I₂₁) | 34.0 | 20.2 | 14.7 | 31.0 | ASTM D-1238 |
| | | | | | (190° C., 21.6 kg) |
| MFR (I₂₁/I₂) | 31.4 | 20.6 | 15.8 | 31.5 | |
| Density (g/cm3) | 0.9187 | 0.9176 | 0.9190 | 0.9163 | ASTM D 792 |
| 1% Secant MD | 29,016 | 25,347 | 26,871 | 23564 | ASTM D790-10 |
| (psi) | | | | | (Procedure A, 1.3 mm/min). |
| 1% Secant TD | 37,231 | 30,084 | 29,344 | 28726 | ASTM D790-10 |
| (psi) | | | | | (Procedure A, 1.3 mm/min). |
| Yield Strength | 1,365 | 1,277 | 1,336 | 1209 | |
| MD (psi) | | | | | |
| Yield Strength | 1,486 | 1,356 | 1,427 | 1361 | |
| TD (psi) | | | | | |
| Elongation at | 5.9 | 6.0 | 6 | 6.3 | |
| Yield MD (%) | | | | | |
| Elongation at | 5.4 | 5.9 | 7 | 8.5 | |
| Yield TD (%) | | | | | |
| Tensile Strength | 9,484 | 9,943 | 10071 | 8052 | |
| MD (psi) | | | | | |
| Tensile Strength | 7516 | 8,475 | 7936 | 7466 | |
| TD (psi) | | | | | |
| Elongation MD | 440 | 451 | 503 | 457 | |
| @ Break (%) | | | | | |
| Elongation TD @ | 690 | 669 | 640 | 710 | |
| Break (%) | | | | | |
| Elmendorf Tear | 325 | 253 | 236 | 273 | ASTM D-1922 |
| MD (g/mil) | | | | | |
| Elmendorf Tear | 451 | 441 | 414 | 597 | ASTM D-1922 |
| TD (g/mil) | | | | | |
| Dart Impact | 672 | 761 | 555 | 497 | ASTM D-1709-09 |
| Resistance | | | | | (Method A) |
| (g/mil) | | | | | |
| Haze (%) | 24.1 | 17.3 | 29 | 10.7 | |
| Gloss MD (GU) | 26 | 32 | 25 | 53 | ASTM D2457-08 |
| Gloss TD (GU) | 27 | 33 | 27 | 51 | ASTM D2457-08 |
| Puncture | 9.4 | 10.8 | 8.3 | 10.0 | Univation Method |
| Strength | | | | | |
| Resistance | | | | | |
| (lbs/mil) | | | | | |

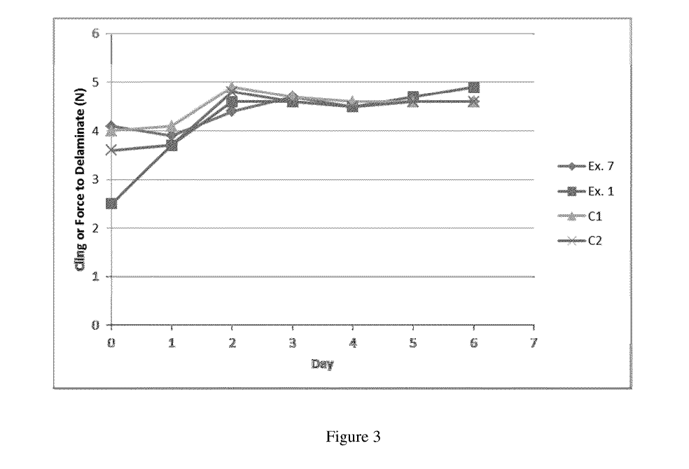

As shown in Table 2, the polyethylene of Example 7 had a significantly lower melt flow ratio as compared to Example 1. The polyethylene film of Ex. 7, however, showed a significantly accelerated rate of cling development as compared to Ex. 1. More particularly, the rate of cling development versus time is graphically depicted in FIG. 3 and shown in tabular form in Table 3 below for Ex. 1, Ex. 7 and comparative examples C1 and C2.

TABLE 3
Rate of Cling Development

| | Ex. 1 | Ex. 7 | C1 | C2 |
|---|---|---|---|---|
| | Cling | Cling | Cling | Cling |
| Day | (N) | (N) | (N) | (N) |
| 0 | 2.5 | 4.1 | 4 | 3.6 |
| 1 | 3.7 | 3.9 | 4.1 | 3.7 |
| 2 | 4.6 | 4.4 | 4.9 | 4.8 |
| 3 | 4.6 | 4.7 | 4.7 | 4.6 |
| 4 | 4.5 | 4.5 | 4.6 | 4.5 |
| 5 | 4.7 | 4.6 | 4.6 | 4.6 |
| 6 | 4.9 | 4.6 | 4.6 | 4.6 |

The data shown in Table 3 and FIG. 3 of the present application represent the force required to delaminate the test sample according to test methods similar to those of the ASTM Standard Test Method for Peel Cling of Stretch Wrap Film (ASTM D5458-95 (Reapproved 2012)). To generate the measurements, the procedures of ASTM D5458-95 were followed precisely with the following modifications.

First, ASTM D5458-95 calls for the use of a load cell having 500 gram capacity. The tests of these examples used a 10N capacity load cell. ASTM D5458-95 also describes allowing the test film rolls to condition for at least 24 hours at room temperature prior to testing. Commercial film production facilities often are not able to allow the rolls to sit and condition for 24 hours or more. Accordingly, in the test method used to generate the data in Table 3, the film was tested less than two (2) hours after molding to determine the Day 0 data point. Following the Day 0 test, the film was maintained at a room temperature of about 25° C. Each subsequent test was conducted on subsequent days (i.e. in approximately 24-hour increments; thus, the Day 1 test was approximately 24 hours after the Day 0 test, the Day 2 test was approximately 48 hours after the Day 0 test, and so forth) to show the rate of cling development.

Second, the samples described herein were rolled onto the test apparatus with a one kilogram (1 kg) roller, to smooth out wrinkles and compact the film specimens to improve the consistency with which pressure is applied to the film. ASTM D5458-95 describes use of a brush applicator for this purpose. The samples described herein were also pulled away from the test apparatus at a rate of 125 mm/minute.

Lastly, ASTM D5458-95 says to report the mean value for 3 specimens. The data reported here is the mean value for 5 specimens. ASTM D5458-95 also says the cling values should be reported in units of Newtons/mm. In Table 3 and FIG. 3, the cling values are reported in units of Newtons, recognizing that all of the samples tested were of the same shape and size and were therefore normalized by the experimental procedure. For repetition of the testing herein, use of samples having the sizes prescribed by the ASTM standard is appropriate.

As shown in Table 3, the cling value for the films of Ex. 7, and C1 and C2 all showed a fast development in cling as compared to Ex. 1. For example, the ratio of initial cling (day 0 or time equal to zero) to cling at 2 days for Example 7 was 0.93, while the ratio of initial cling (day 0 or time equal to zero) to cling at 2 days for Example 1 was only 0.54. In another example, the ratio of initial cling (day 0 or time equal to zero) to cling at 6 days for Example 7 was 0.89, while the ratio of initial cling (day 0 or time equal to zero) to cling at 6 days for Example 1 was 0.53. Accordingly, Example 7 showed a significant increase in the rate of cling development and was comparable to that exhibited by the comparative examples C2 and C3, which are the conventional polyethylenes EXCEED 1018CA and ELITE 5400G, respectively.

There are many factors that may influence the rate of cling development. The amount of tackifier added in the masterbatch, the molecular weight of the tackifier used, the resin blending techniques, the co-extrusion conditions, the storage temperature of the film, and the film thickness are all examples of parameters that those skilled in the art believe influence the rate of cling development and the ultimate cling force. For each of the examples described herein, the film thickness was held constant at less than twenty (20) microns and the storage temperature was held at 25° C. Additionally, the extrusion conditions and additives were held constant both in quantity added and in compositions added. Finally, other examples were run to evaluate the influence of resin blending on the rate of cling development and no significant impact was observed in tests ranging from blending with less than ten percent (10%) low density polyethylene and up to forty-five percent (45%) Ziegler-Natta linear low density polyethylene.

Example 7 illustrates that the benefits in mechanical properties that can be obtained using a hafnium containing catalyst can be combined with the rapid cling development properties desired by end users, and comparable to non-hafnium catalyzed film products, by controlling the reaction conditions to obtain a suitably low melt flow rate (I₂₁/I₂), such as between about 18 and about 23. A low melt flow rate, such as between about 18 and about 23, may be obtained by controlling the reaction temperature to between about 80° C. to 88° C. as described herein. A wide range of base polymers can be produced having suitably low melt flow rate to improve the rate of cling development while providing a broad range of mechanical properties to meet end users application needs.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A method for making a polyethylene film, comprising:
contacting ethylene and one or more comonomers with a hafnium-based metallocene catalyst within a polymerization reactor at a temperature of from 81° C. to 88° C. and an ethylene partial pressure of from about 825 kPa to about 1,800 kPa to produce a polyethylene, the polyethylene comprising:
a solubility distribution breadth index (SDBI) of from 18° C. to less than or equal to 23° C.; and
a melt flow ratio (I₂₁/I₂) of from about 18 to about 23, wherein I₂₁ is measured according to ASTM D 1238 (190° C., 21.6 kg) and I₂ is measured according to ASTM D 1238 (190° C., 2.16 kg);
combining the polyethylene with at least one tackifier to produce a blended mixture; and
forming the blended mixture into a film, wherein at a time zero after forming the film, the film has a cling value that is at least 60% of a cling value the film has at 48 hours after time zero, and wherein time zero is equal to less than 24 hours.

2. The method of claim 1, wherein forming the mixture into a film comprises using a blown film process.

3. The method of claim 2, wherein said time zero is less than two (2) hours after the film has been formed.

4. The method of claim 1, wherein the polyethylene has a melt index (I₂) less than 1.5 and a flow index (I₂₁) of from about 16 to about 28.

5. The method of claim 1, wherein at said time zero after forming the film, the film has a cling value that is at least 70% of a cling value the film has at 48 hours after said time zero.

6. The method of claim 1, wherein at said time zero after forming the film, the film has a cling value that is at least 80% of a cling value the film has at 48 hours after said time zero.

7. The method of claim 1, wherein a 25 μm film made from the polyethylene by a blown film process has a 1% secant modulus greater than 25,000 psi, measured according to ASTM D790-10 (Procedure A, 1.3 mm/min); a dart impact resistance greater than 500 g/mil, measured according to ASTM D-1709-09 (Method A); and a machine direction tear strength of less than 500 g/mil, measured according to ASTM D-1922.

8. The method of claim 1, wherein the film has a 1% secant modulus greater than 25,000 psi, measured according to ASTM D790-10 (Procedure A, 1.3 mm/min); a dart impact resistance greater than 500 g/mil, measured according to ASTM D-1709-09 (Method A); and a machine direction tear strength of less than 350 g/mil, measured according to ASTM D-1922.

9. The method of claim 1, wherein the film has a thickness from about 5 μm to about 100 μm.

10. The method of claim 1, wherein the tackifier is present in an amount from about 1 wt % to about 8 wt %, based on the combined weight of the polyethylene and the tackifier.

11. The method of claim 1, wherein the tackifier is present in an amount from about 3 wt % to about 5 wt %, based on the combined weight of the polyethylene and the tackifier.

12. The method of claim 1, wherein the film is a monolayer film.

13. The method of claim 1, wherein the film is a multilayer film.

14. The method of claim 2, wherein the film is a stretch cling film.

15. The method of claim 1, further comprising blending the polyethylene with one or more tackifiers and one or more second polyethylenes selected from the group consisting of low density polyethylenes and linear low density polyethylenes to produce a polymer blend, and forming the polymer blend into a film using a blown film process.

16.-35. (canceled)
